(19) United States
(12) Patent Application Publication
(10) Pub. No.: US 2022/0365508 A1
(43) Pub. Date: Nov. 17, 2022

(54) SERVICE CONSOLE LOG PROCESSING DEVICES, SYSTEMS, AND METHODS

(71) Applicant: Bell and Howell, LLC, Durham, NC (US)

(72) Inventors: Haroon Abbu, Morrisville, NC (US); Raghavendra Nayak, Morrisville, NC (US); Larry Allen Blue, Chapel Hill, NC (US)

(21) Appl. No.: 17/507,176

(22) Filed: Oct. 21, 2021

Related U.S. Application Data
(60) Provisional application No. 63/187,640, filed on May 12, 2021.

(51) Int. Cl. G05B 19/408; G05B 19/4063

(52) U.S. Cl. CPC G05B 19/408; G05B 19/4063; G05B 2219/35291

(57) ABSTRACT

Systems for reducing reduce downtime include industrial machines, sensor(s) associated therewith, edge agent(s), central controller(s), and display(s). The sensor(s) detect operational parameters (e.g., error condition) of the industrial machines associated therewith. The edge agent(s) receive information (e.g., logging messages) from the industrial machines and/or information from the sensors. The central controller(s). The central controllers receive and transform the information into standardized logging messages that are formatted identically, analyze the standardized logging messages to determine occurrence(s) of a current or anticipated error condition for any of the industrial machines, and transmit an alert and/or notification to the display(s) so users can take corrective action to ensure proper operation of the industrial machines. Such a system can be used in performing a corresponding method for reducing downtime associated with current or anticipated error conditions of such industrial machines.

### CROSS-REFERENCE TO RELATED APPLICATION

This patent application claims priority to U.S. Provisional Patent Application Ser. No. 63/187,640, filed on May 12, 2021, the entire content of which is incorporated by reference herein.

### TECHNICAL FIELD

The disclosure herein relates generally to log processing, and more particularly to service console log processing devices, systems, and methods capable of improving the efficiency of diagnosis and repair of malfunctioning equipment.

### BACKGROUND

Existing production mail equipment and other industrial equipment in various fields, as well as new equipment sold to process production mail, primarily use a decades-old service paradigm where operators run scheduled jobs and typically only request service for the equipment when the equipment stops, either intermittently or entirely, or otherwise is in need of repair due to one or more malfunctions.

Until the malfunction is resolved, such equipment either continues to be operated sub-optimally (e.g., in a degraded performance state) or is left idle (e.g., unused entirely). Due to the fact that it is oftentimes not possible to resolve equipment malfunctions instantaneously, whether due to scheduling restrictions, parts, availability, etc., the delay associated with performing repairs on malfunctioning equipment causes a reduction in output or performance of equipment, under-utilization of such equipment, and/or reduces the return on investment (ROI) below an anticipated, or expected level. Given a lack of information regarding the cause of the malfunction for known equipment, service technicians often spend considerable amounts of time merely trying to troubleshoot the malfunction. Additionally, many other types of industrial equipment produce logging messages and other types of messages without a consistent formatting of the logs. This causes many issues with analyzing the different logging messages that are reported because scripts, software, and other automation tools must be customized for each individual type of equipment versus a uniform analysis tool.

As such, there exists a need for devices, systems, and methods capable of improving the efficiency of diagnosis and repair of malfunctioning equipment.

### SUMMARY

According to a first example embodiment, a system for reducing downtime is provided, the system comprising: one or more displays; a plurality of industrial machines configured to generate logging messages, each logging message comprising information regarding a corresponding one of the plurality of industrial machines; one or more sensors positioned on or proximate to one or more of the plurality of industrial machines, wherein each sensor is configured to detect one or more operational parameters for the one or more of the plurality of industrial machines to which the sensor is positioned on or proximate to; one or more edge agents; and one or more central controllers. Each edge agent is associated with one or more industrial machines of the plurality of industrial machines and comprises: one or more processors in communication with the one or more industrial machines with which the edge agent that comprises the one or more processors is associated; and one or more transceivers configured to receive sensor information regarding one or more operational parameters from at least some of the one or more sensors and/or the logging messages from the one or more industrial machines with which the edge agent that comprises the one or more transceivers is associated. Each of the one or more central controllers comprises: one or more processors in communication with at least some of the one or more edge agents; and one or more transceivers. Each of the central controllers is configured to: receive, via the one or more transceivers of the one or more central controllers, the logging messages and the sensor information from the one or more edge agents in communication therewith; transform, via the one or more processors of the one or more central controllers, the logging messages and the sensor information into standardized logging messages, each of which has a same formatting; analyze the standardized logging messages to determine a current or anticipated error condition associated with one or more of the plurality of industrial machines; and automatically transmit, via the one or more transceivers of the one or more central controllers, an alert and/or a notification regarding the current or anticipated error condition to the one or more displays. The one or more displays are configured to receive and display the alert and/or the notification to one or more users of the system.

In some embodiments of the system, the one or more displays comprise a display of a mobile personal electronic device.

In some embodiments of the system, the mobile personal electronic device is configured to transmit one or more commands from the one or more users to deactivate, or change an operational state of, any of the plurality of industrial machines.

In some embodiments of the system, the one or more central controllers comprise a database that includes instances of historical error conditions and historical logging messages that were generated before, during, and/or after each instance of the historical error conditions for any of the plurality of industrial machines.

In some embodiments of the system, the one or more processors of the one or more central controllers are configured to determine the current or anticipated error condition by comparing the standardized logging messages to the historical logging messages.

In some embodiments of the system, the one or more processors of the one or more central controllers are configured to compare the standardized logging messages to the historical logging messages to identify series, or sequences, of the standardized logging messages that are substantially similar to the historical logging messages that were generated before, during, and/or after each instance of the historical error conditions.

In some embodiments of the system, the one or more processors of the one or more central controllers are configured to compare the standardized logging messages to the historical logging messages to identify series, or sequences, of the standardized logging messages that are identical to the historical logging messages that were generated before, during, and/or after each instance of the historical error conditions.

In some embodiments of the system, the plurality of industrial machines comprise at least two different types of industrial machines.

In some embodiments of the system, each edge agent is configured to receive logging messages from each of the different types of industrial machines.

In some embodiments of the system, each edge agent is located in a same location as the one or more industrial machines from which the edge agent is configured to receive the logging messages.

In some embodiments of the system, the plurality of industrial machines comprises one or more industrial mail processing machines.

In some embodiments of the system, the one or more transceivers of the one or more central controllers are configured to transmit one or more commands to any of the plurality of industrial machines for which the current or anticipated error condition is determined, wherein any of the plurality of industrial machines that receives the one or more commands are configured to automatically perform one or more actions to correct, or prevent an occurrence of, the current or anticipated error condition.

In some embodiments of the system, the one or more actions comprise any of powering on, powering off, power cycling, and/or starting or stopping operation of a part or component associated with any of the plurality of industrial machines that receives the one or more commands.

In some embodiments of the system, the one or more processors of the one or more central controllers are configured to generate, and the one or more transceivers of the one or more central controllers are configured to transmit, a work order to a service technician for any of the plurality of industrial machines with which the current or anticipated error condition is associated, the work order comprising instructions for the service technician to correct, or prevent an occurrence of, the current or anticipated error condition.

In some embodiments of the system, the one or more displays are configured to receive information regarding a performance of one or more of the plurality of industrial machines and to display the information regarding the performance of the one or more of the plurality of industrial machines.

In some embodiments of the system, the logging messages generated by the plurality of industrial machines and/or the one or more operational parameters detected by the one or more sensors comprises and/or indicates one or more error conditions associated with one or more of the plurality of industrial machines.

According to a second example embodiment, a method of reducing downtime is provided, the method comprising steps of: performing, using a plurality of industrial machines, one or more industrial activities, wherein each industrial machine can generate logging messages, each logging message comprising information regarding a corresponding one of the plurality of industrial machines that generates the logging message; positioning one or more sensors on or proximate to one or more of the plurality of industrial machines, wherein each sensor detects one or more operational parameters for the one or more of the plurality of industrial machines to which the sensor is positioned on or proximate to; providing one or more edge agents, each of which is associated with one or more industrial machines of the plurality of industrial machines and comprises one or more processors and one or more transceivers; connecting the one or more processors in communication with the one or more industrial machines with which the edge agent that comprises the one or more processors is associated; receiving, via the one or more transceivers, sensor information regarding one or more operational parameters from at least some of the one or more sensors and/or the logging messages from the one or more industrial machines with which the edge agent that comprises the one or more transceivers is associated; connecting one or more central controllers in communication with at least some of the one or more edge agents; receiving, via the one or more transceivers of the one or more central controllers, the logging messages and the sensor information from the one or more edge agents in communication therewith; transforming, using the one or more processors of the one or more central controllers, the logging messages and the sensor information into standardized logging messages, each of which has a same formatting; analyzing, using the one or more processors of the one or more central controllers, the standardized logging messages to determine a current or anticipated error condition associated with one or more of the plurality of industrial machines; transmitting, automatically and via the one or more transceivers of the one or more central controllers, an alert and/or a notification regarding the current or anticipated error condition to one or more displays; and displaying, on the one or more displays, the alert and/or the notification to one or more users.

In some embodiments of the method, the one or more displays comprise a display of a mobile personal electronic device.

In some embodiments of the method, the mobile personal electronic device comprises an input and a transceiver, the method comprising transmitting one or more commands from the one or more users to deactivate, or change an operational state of, any of the plurality of industrial machines.

In some embodiments, the method comprises providing, in communication with the one or more central controllers, a database that includes instances of historical error conditions and historical logging messages that were generated before, during, and/or after each instance of the historical error conditions for any of the plurality of industrial machines.

In some embodiments, the method comprises determining, using the one or more processors of at least one of the one or more central controllers, the current or anticipated error condition by comparing the standardized logging messages to the historical logging messages.

In some embodiments, the method comprises comparing, using the one or more processors of at least one of the one or more central controllers, the standardized logging messages to the historical logging to identify series, or sequences, of the standardized logging messages that are substantially similar to the historical logging messages that were generated before, during, and/or after each instance of the historical error conditions.

In some embodiments, the method comprises comparing, using the one or more processors of at least one of the one or more central controllers, the standardized logging messages to the historical logging messages to identify series, or sequence, of the standardized logging messages that are identical to the historical logging messages that were generated before, during, and/or after each instance of the historical error conditions.

In some embodiments of the method, the plurality of industrial machines comprise at least two different types of industrial machines.

In some embodiments, the method comprises receiving, for each edge agent, logging messages from each of the different types of industrial machines.

In some embodiments of the method, each edge agent is located in a same location as the one or more industrial machines from which the edge agent receives the logging messages.

In some embodiments of the method, the plurality of industrial machines comprises one or more industrial mail processing machines.

In some embodiments, the method comprises: transmitting, using one or more transceivers of at least one of the one or more central controllers, one or more commands to any of the plurality of industrial machines for which the current or anticipated error condition is determined; and automatically performing, at any of the plurality of industrial machines that receives the one or more commands, one or more actions to correct, or prevent an occurrence of, the current or anticipated error condition.

In some embodiments of the method, the one or more actions comprise any or powering on, powering off, power cycling, and/or starting or stopping operation of a part or component associated with any of the plurality of industrial machines that receives the one or more commands.

In some embodiments, the method comprises: generating, using the one or more processors of at least one of the one or more central controllers, a work order for any of the plurality of industrial machines with which the current or anticipated error condition is associated, wherein the work order comprises instructions for a service technician to perform to correct, or prevent an occurrence of, the current or anticipated error condition; and transmitting, using the one or more transceivers of the at least one of the one or more central controllers, the work order to the service technician.

In some embodiments, the method comprises: receiving, at the one or more displays, information regarding a performance of one or more of the plurality of industrial machines; and displaying, on the one or more displays, the information regarding the performance of the one or more of the plurality of industrial machines.

In some embodiments of the method, the logging messages generated by the plurality of industrial machines and/or the one or more operational parameters detected by the one or more sensors comprises and/or indicates one or more error conditions associated with one or more of the plurality of industrial machines.

### BRIEF DESCRIPTION OF THE DRAWINGS

FIG. 1A is a schematic illustration of a system for reducing downtime associated with one or more error conditions of industrial machines.

FIG. 1B is a schematic illustration of one of the edge agents of FIG. 1A.

FIG. 1C is a schematic illustration of one of the central controllers of FIG. 1A.

FIGS. 2A and 2B are a flow chart showing various steps of a method for reducing downtime associated with one or more error conditions of industrial machines.

FIG. 3 is a schematic illustration of an example industrial machine communicating bidirectionally with an example edge agent.

FIG. 4 is a schematic illustration of an example industrial machine transmitting logging data to an example edge agent.

FIG. 5 is a schematic illustration of an example network topology, showing connections between an example edge agent and an example central controller.

FIG. 6 is a schematic illustration of an example of the logging data from an industrial machine being converted into standardized logging messages by the central controller.

FIG. 7 is a schematic illustration of example actions the central controller can execute after the standardized logging messages are processed.

FIG. 8 is an example embodiment of a data visualization that can be shown to a user on the display of the system of FIG. 1A to monitor the performance of the industrial machines.

FIG. 9 is an example embodiment of a graphical chart for presenting data to a user on the display of the system of FIG. 1A to help monitor the performance of the industrial machines.

### DETAILED DESCRIPTION

The subject matter herein provides example service console logging message processing systems and methods. Such systems and methods use so-called “edge agents” that are installed on or in communication with industrial machines or industrial equipment in the field (e.g., on the manufacturing floor, warehouse, or any other suitable location where industrial machines are located and operated to perform an industrial task). Edge agents include hardware and software designed to receive log data (e.g., logging messages, log messages, or logs) from one or more of the industrial machines, either alone or in conjunction with sensor information received from sensors that are positioned on or associated with (e.g., positioned adjacent to, in order to detect operational anomalies) the industrial machines. The edge agents transmit or stream (e.g., in real-time) the logging data to a central controller, which can also be referred to herein as a central processing engine.

The logging data and/or sensor information contain information and data related to the health (e.g., remaining useful life, based on reliability data), operational status (e.g., on/off), performance (e.g., throughput or productivity metrics), etc. of each of the industrial machines with which the sensors are associated, or from which the logging data is received. The central controller receives the logging data from one or more edge agents. The edge agents can be co-located with the central controller or at any place around the world where industrial machines, about which logging data and/or sensor information is desired to be known, are located. Thus, the edge agents are connected to the central controller via communication networks, such as the Internet. Once the logging data and/or sensor information is received at the central controller, the logging data and/or sensor information is transformed into standardized logging messages, all of which have the same format. In some embodiments, one or more edge agent is configured to pre-process certain information (e.g., of the logging data and/or the sensor information) prior to such information being sent to the central controller.

Different types of industrial machines, and even industrial machines that are of a same type but are produced by different manufacturers, are known to produce logging data regarding the health, operational status, performance, etc. of the industrial machine that is different in terms of, for example and without limitation, message formatting, message content, and/or even the parameters being monitored. Such logging data regarding the operation of such industrial machines, is undeniably useful, but it is at present not possible for known systems to process and understand the data contained therein when the logging data may be presented and/or transmitted in any of a plurality of different formats.

Thus, the central controller advantageously receives the logging data and/or sensor information in a so-called “raw” form, meaning that the information contained therein is unformatted, and transforms the logging data and/or the sensor information into standardized logging messages, each of which has the same formatting to provide enhanced ability to categorize, classify, index, and/or search to allow for the available information to be utilized to determine a current or anticipated error condition. The term “current” means happening in real-time, or an ongoing error condition that has not yet been remedied, even if the industrial machine has been taken offline (e.g., intentionally rendered inoperable) due to the error condition. The term “anticipated” means an error condition that has not yet happened, but which is expected to happen within a specified window of time; this is often referred to as predictive failure analysis (PFA) and is exceptionally helpful in maintaining the operational status of industrial machines by anticipating failures before they happen so that any necessary parts can be ordered and service technicians can be assigned to carry out the repair at a time that is pre-planned to minimize downtime for the industrial machine and also of other industrial machines that may be interoperable with the industrial machine that needs the preventive service to be performed.

After being generated, the standardized logging messages are indexed and stored for further processing. Among the advantages provided by the presently disclosed subject matter is that it is now possible to detect error conditions and other negative events (e.g., events that indicate the industrial machine is still operable, but the remaining useful life is or has been degraded) in the industrial machine during or, preferably, before the actual occurrence of the error conditions or negative events, so that staff (e.g., service technicians or other qualified maintenance repair personnel) can be alerted to the current or anticipated error condition and also aid in performing proactive maintenance to remedy the error condition before the industrial machine experiences unscheduled downtime, which can have a significant negative impact on productivity on not only the impacted industrial machine but also to other industrial machinery that may be associated with (e.g., operates as part of an assembly line with) the impacted industrial machine.

In some embodiments, the central controller transmits commands to any of the industrial machines that may be impacted by the current or anticipated error condition, such that the impacted industrial machines automatically perform one or more actions to correct or, preferably, prevent, an occurrence of the current or anticipated error condition. Examples of such commands include, for example and without limitation, power off, power on, power cycle, and/or start or stop (e.g., engage or disengage, activate or deactivate, etc.) operation of individual parts, components, and/or subsystems of impacted industrial equipment based on the processing of the standardized logging messages and whether any error conditions are detected or anticipated. In some such embodiments, the central controller transmits data, such as an alert or notification, to a display for visualization, performance monitoring, etc. of the industrial machines. In some cases, the edge agent(s) implement certain prescribed corrective actions immediately, based on pre-processed information contained in the logging data and/or sensor information, prior to the logging data and/or sensor information being sent to the central controller.

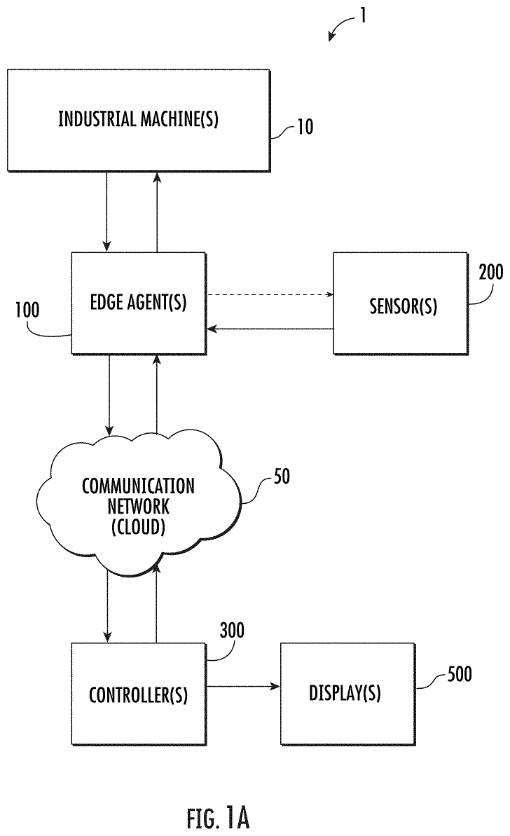

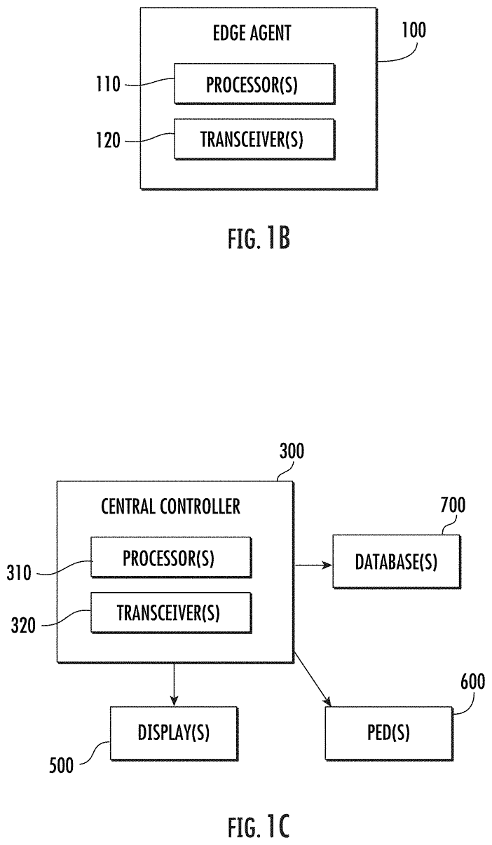

Referring to FIG. 1A, a system, generally designated 1, for reducing downtime associated with one or more error conditions of industrial machines is schematically illustrated therein. As shown, the system 1 has one or more industrial machines 10, one or more (e.g., a plurality of) edge agents 100, one or more (e.g., a plurality of) sensors 200 a communication network 50, one or more (e.g., a plurality of) central controllers 300, and one or more (e.g., a plurality of) displays 400.

Each edge agent 100 is in communication with one or more of (e.g., a plurality of) of the industrial machines 10 and/or with one or more of (e.g., a plurality of) the sensors 200. In some embodiments, there are a plurality of geographically distanced locations at which one or more industrial machines 10 are operating; in such embodiments, there may be a single edge agent 100, or a plurality of edge agents 100, installed at least location.

Each sensor 200 is installed on an industrial machine 10 or positioned at a location sufficiently proximate to one or more industrial machines 10 to detect one or more operational parameters (e.g., a vibration, speed, etc.) of any of the one or more industrial machines 10 to which such sensor is in sufficiently close proximity, these one or more operational parameters indicating an error condition for the one or more industrial machines 10 and/or an out-of-specification or out-of-tolerance operational state of the one or more industrial machines 10 that indicates a failure, malfunction, and/or error condition is likely to occur on the one or more industrial machines 10 within a prescribed period of time. Sensors 200 can be of a type that transmits a periodic, continuous, and/or real-time, raw data value to the edge agent 100 to which the sensor 200 is connected. Sensors 200 can be of a type that comprises a processor, memory, and the like (e.g., as a system-on-chip, or SoC), and is configured to perform a level of diagnostic processing for the one or more operational parameters being detected, such that such sensors 200 send alerts, whether formatted or in a raw, unprocessed, form to the edge agent with which the sensor 200 is in communication only when an out-of-specification or out-of-tolerance operational state of the one or more industrial machines 10 has been detected. Any mixture of such sensors 200 can be provided without limitation.

Each central controller 300 is in communication, via the communication network 50, with each of (e.g., all of), or a subset consisting of less than all of, the edge agents 200, which can be co-located or located at different locations (e.g., different cities, states, countries, etc.) from each other.

In some embodiments, there is only a single edge agent 100, with or without any sensors 200, installed at a particular facility, installation site, and/or geographic location. In such an embodiment, the single edge agent 200 is configured to receive logging data from all specified industrial machines 10 installed at the facility and/or sensor information from sensors 200 that are associated with one or more of industrial machines 10 installed at the facility, which can be the same as, greater than, or less than the quantity of the specified industrial machines 10. In some embodiments, the industrial machines 10 on which the sensors 200 are installed, or with which the sensors 200 are associated (e.g., sufficiently proximate to, allowing for detection of one or more operational parameters thereof), are entirely different from the specified industrial machines 10 from which the edge agent 10 is configured to receive logging data, meaning that none of such specified industrial machines 10 have any sensors 200 (e.g., no additional sensors, beyond those sensors that are provided by a manufacturer of such specified industrial machines 10) associated therewith.

In some embodiments, there are a plurality of edge agents 100, with or without any sensors 200, installed at a particular facility, installation site, and/or geographic location. In some such embodiments, each edge agent 100 is configured to receive logging data from a subset of (e.g., less than all of) the industrial machines 10 and/or from a subset of (e.g., less than all of) the sensors 200 located at the facility, installation site, and/or geographic location. In some other such embodiments, all of the edge agents 100 are connected to, and in communication with, all of the industrial machines 10 and/or all of the sensors 200 located at the facility, installation site, and/or geographic location.

In any of such embodiments, the edge agents 100 may be provided in a redundant manner, so that multiple edge agents 100 are in communication with each industrial machine 10 and/or sensor 200 and may be configured such that the redundant edge agents 100 operate concurrently with (e.g., simultaneously with) the primary redundant edge agents 100, the redundant edge agents 100 only transmitting logging data and/or sensor information to the one or more central controllers associated therewith upon a failure, fault condition, malfunction, etc. being detected in a corresponding one of the primary edge agents 100. In other redundant operating modes, the redundant edge agents 100 may be kept in a sleep, hibernate, low power, or off state until a failure, fault condition, malfunction, etc. is detected in a corresponding one of the primary edge agents 100. In some such embodiments, the primary and redundant edge agents 100 are connected to the one or more central controllers 300 by different communication networks. Examples of such different communication networks can include different connection types to a same communication network (e.g., wireless and wired connections to the Internet, in which the wireless connection is used as a redundant communication connection for transmitting logging data to the one or more central controllers 300 upon failure of the wired connection) or an entirely different communication network (e.g., the Internet as the communication network for the primary edge agents 100 and a satellite-based data transmission network for the redundant edge agents 100). In some embodiments, the primary edge agents 100 are connected to only the primary communication network 50 and the redundant edge agents 100 are connected to both the primary and secondary communication networks 50.

In some embodiments, there is only a single edge agent 100 for each industrial machine 100 installed at a particular facility, installation site, and/or geographic location. In such embodiments having one or more edge agents 100 dedicated to a single industrial machine 10, each edge agent 100 is configured to receive logging data from a different one of a plurality of industrial machines 10 (e.g., every edge agent 100 is attached to and/or is in communication with and configured to receive logging data from only one industrial machine 10, which does not send any logging data to any other edge agent 100). In such embodiments, a single edge agent 100 can be associated with a single sensor 200 or one or more sensors 200. In some embodiments, the sensors 200 may be in the form of an SoC with a processor, memory, a transceiver, and the like and configured to process the sensor information and act as a de facto edge agent, communicating directly with the one or more central controllers 300 (e.g., via the communication network 50).

In some embodiments, the system 1 has a plurality of central controllers 300, which are configured to work separately from each other or together (e.g., as a redundant network of central controllers 300). In an example embodiment having redundant operation, one of (or a subset of) a plurality of central controllers 300 is designated as a primary central controller 300 and another of (or a subset of) the plurality of central controllers 300 is designated as a redundant central controller 300. The primary and redundant central controllers 300 are configured to not both operate at a same time (e.g., the primary and redundant central controllers 300 do not operate concurrently or simultaneously) and, upon failure of any of the primary central controllers 300, one of the redundant central controllers 300 is activated to assume the functionality previously performed by the failed primary central controller 300. Such an arrangement is advantageous in providing redundancy when a failure occurs. In some embodiments, the system 1 has a plurality of central controllers 300, each of which is simultaneously operable (e.g., active, turned on, initialized, etc.) to load balance the quantity of edge agents 100 and/or sensors 200 from which the central controller 300 is currently receiving logging data and/or sensor information. Thus, the plurality of central controllers 300 are configured to dynamically reassign edge agents 100 and/or sensors 200 to another of the plurality of central controllers 300 based on the quantity of edge agents 100 and/or sensors 200 with which each central controller 300 is in communication, so that each central controller 300 has substantially the same quantity (e.g., a same quantity per processor, allowing for variations of ±1) of edge agents 100 and/or sensors 200 associated therewith.

In FIG. 1A, the system 1 has two central controllers 300 and a plurality of edge agents 100, each of which is in communication with the two central controllers 300. In some embodiments, one of the central controllers 300 can processes the logging data from a subset of (e.g., half) of the edge agents 100 and the other central controller 300 processes the logging data from the other subset of the edge agents 100. Such a configuration of the system 1 advantageously preserves resources and each of the central controllers 300 can utilize the processing resources associated therewith to ensure the industrial machines 10 associated therewith continue to operate. In some other embodiments, one of the central controllers 300 is assigned to operate as an “active” (e.g., primary) central controller 300 and receives, transforms, and otherwise processes the logging data from each (e.g., all) of the edge agents 100 and the other of the central controllers 300 is assigned to operate as a “standby” (e.g., redundant) central controller 300. Both of the central controllers 300 are in communication with all of the edge agents 100, however, unless the active central controller 300 experiences a failure, malfunction, etc., the standby central controller 300 will remain in an inactive, sleep, hibernate, off, etc. state and does not receive, transform, or otherwise process any of the logging data from any of the plurality of edge agents 100. In another example embodiment, the system 1 has only a single central controller 300 (e.g., system 1 has no redundancy or simultaneous operation of a plurality of central controllers 300) and is configured to process logging data from all of the plurality of edge agents 100 without any failover or resource preservation characteristics.

As shown in FIG. 1A, the central controllers 300 are in communication with each of the edge agents 100 via a suitable communications network 50 (e.g., Internet, 3G, LTE, 5G, WAN, Wi-Fi®, Bluetooth®, etc.). In some embodiments, one or more of the central controllers 300 is a computer or server, such as a cloud server. Although depicted as being connected to the edge agents 100 of only a single site in FIG. 1A, the central controllers 300 are configured to receive logging data from more than one facility, installation site, and/or geographic location, each of which has one or more edge agents 100 and/or sensors 200 associated with one or more industrial machines 10 and in communication with the central controllers 300. For example, a plurality of facilities, installation sites, and the like, which are located at different locations across a geographic region, each have one or more industrial machines 10 and one or more compatible edge agents 100 and/or sensors 200, the edge agents 100 of each facility or installation site each being in communication with the central controllers 300 through the communications network 50. In the system 1, the central controllers 300 are in communication with one or more (e.g., a plurality of) displays 500 and are configured to transmit visual displays of processed data as described herein. The display 500 can be, for example and without limitation, a dedicated display and/or a display of a personal electronic device, such as a mobile phone, tablet, personal computer, etc.

In an advantageous example embodiment, the system 1 is configured such that the central controllers 300 are configured to transmit one or more commands, such as, for example and without limitation, command(s) to power off, power on, power cycle, and/or control operation of (e.g., start and/or stop) a part or component associated with any of the plurality of industrial machines 10 that receives the one or more commands and with which the central controller 300 is in communication via one or more edge agents 100. For example, if one of the central controllers 300 receives logging data indicating that one of the industrial machines 10 is in an error condition and then determines that a possible solution to resolve the error condition is to initiate a power cycle for the affected industrial machine 10, the central controller 300 is configured to transmit a power cycle command to the affected industrial machine 10, via the communication network 50 and one or more of the edge agents 100, in an attempt to resolve the error condition. As such, the power cycle command is transmitted through the communications network 50 to one of the edge agents 100 that is in bi-directional communication with the affected industrial equipment 10 and the edge agent 100 is configured to transmit the power cycle command to the affected industrial machine 10.

In some embodiments, the edge agents 100 are configured to transmit and receive communications, including logging data, instructions, and other network communications between the industrial machines 10 and the central controllers 300. In some other embodiments, the edge agents 100 are configured to control some of the processes running on the industrial machines 10. In such an embodiment, the edge agents 100 are configured to be able to initiate, for any of the industrial machines 10, a command to power off, power on, power cycle, switch networks, run repair subroutines, etc. based on the command(s) received from the central controllers 300 and the control capabilities of the edge agent 100. For example, some edge agents 100 may have more or different control capabilities than other edge agents 100 depending on the type and design of each edge agent 100.

The central controllers 300, which can be so-called “cloud” devices, can be configured to control the edge agents 100 and the edge agents 100 can be configured to control the industrial machines 10. For example and without limitation, the central controllers 300 can be configured to restart, reinitialize, and/or reconfigured the edge agents 100 remotely (e.g., from or via the cloud). The edge agents 100, based on algorithms, are able to send commands to execute functions on the industrial equipment 10 via the edge agents 100, such as, for example, power cycle an industrial machine 10 or move a feeding and/or cutting mechanism to a certain position/status.

FIG. 1B is a schematic illustration of an example edge agent 100, according to some example embodiments of the present disclosure. In some embodiments, each edge agent 100 comprises one or more processors 110 and one or more transceivers 120 or other receiving and transmitting device. In some embodiments, the edge agents 100 are configured to communicate with the industrial equipment 10 and/or the sensors 200 using a wired connection (e.g., via an ethernet connection) or a wireless connection (e.g., Wi-Fi®, Bluetooth®, 3G, LTE, 5G, etc.) In some embodiments, the edge agents 100 are configured to communicate with the industrial machine 10 and/or the sensors 200, receive the logging data at the transceiver 120, and transmit the logging data to the central controller 300 through the communication network 50 using the transceiver 120.

In some embodiments, the edge agents 100 are configured to collect logging data from one or more pieces of the industrial equipment 10 and/or sensor information from one or more sensors 200. For example, the edge agents 100 are configured to proactively monitor (e.g., search for) configured files where the industrial equipment 10 is configured to write logging data (e.g., error logs, status, and/or error messages) during operation of the industrial equipment 10. The edge agents may, in some embodiments, be configured to receive sensor information from the sensors 200. The logging data and/or the sensor information are monitored continuously by an associated one of the edge agents 100 of the system 1 and is transmitted (e.g., streamed in real-time) to a central controller 300, where further filtering and transformation of the logging data and/or sensor information occurs in real-time. The edge agents 100 and the central controllers 300 are configured to monitor logging data and/or sensor information and to issue commands on the basis of the same, based on the types of industrial machines for which such logging data and/or sensor information is being generated.

In some embodiments, the contents of the logging data are heterogeneous in nature, meaning each industrial machine 10 is generating logging data (e.g., errors, or error messages), in a proprietary format that is different from other industrial machines 10, even other industrial machines 10 of a same type. The proprietary format depends largely on how the manufacturer elected to implement data logging functionality. There is currently no standard method of writing such logging data, even between different manufacturers of the same type of industrial machine. These logs were typically intended for use in a so-called “debug” process and were often never intended for real-time data analytics usage.

In some such embodiments, the logging data must be decoded and then re-encoded to a standardized messaging format. This requires initial data modeling during design and implementation of such systems and methods, then automation to perform the functionality disclosed herein, which will be scripted in the system process. In addition, data modelling requires knowledge of the each particular type of industrial machine, error conditions, and possible corrective actions associated therewith.

FIG. 1C schematically shows an example embodiment of a central controller 300. In the example embodiment shown, the central controller 300 can be a server, personal computer, or any other suitable computing system and comprises one or more processors 310 and one or more transceivers 320. As shown in FIG. 1C, the central controller 300 is in communication with and/or connected to a display 500, where the central controller 300 is configured to display any of a plurality of visualizations of the logging data and/or sensor information that has been received and processed by the central controller 300. The central controller 300 is optionally in communication with a personal electronic device 600 that is assigned to, and generally carried by (e.g., on the person of, such as in a pocket, bag, etc.) a user. Such a user can be, for example and without limitation, a systems administrator, an engineer, or service technician associated with the industrial equipment 10. The user can be co-located with the central controller 300, co-located with the industrial equipment 10, or at any suitable location. In some embodiments, the central controllers 300 are configured to relay instructions to the user to perform some function on the industrial equipment 10, including instructions for how to power on, power off, power cycle, or change the operation (e.g., start or stop) of a part or component of the affected industrial equipment 10.

Using the transceiver 320, the central controller 300 is configured to receive logging data and/or sensor information from the edge agents 100 with which the central controller 300 is in communication and to process the logging data and/or sensor information as described herein. In some embodiments, the central controller 300 is configured to process logging data and/or sensor information received from the edge agents 100 as described herein and perform predictive failure analysis to calculate a remaining useful life of a part or component of the industrial machine 10 based on the logging data and/or sensor information received and processed by the central controller 300. The central controller 300 is configured to transform the received logging data and/or sensor information into standardized logging messages with a uniform, or standardized, format for each of the standardized logging messages. Once the predictive failure analysis is complete and the logging data and/or sensor information are processed (e.g., fully processed), the central controller 300 is configured to transmit any necessary commands to any edge agents 100 that are associated with (e.g., in communication with and/or controlled by) the central controller 300 to perform necessary tasks to correct or prevent any current or anticipated error conditions in the industrial machines 10.

In some embodiments, the tasks necessary to be performed to correct or prevent the occurrence of a current or anticipated error condition requires coordination with other industrial machines 10, such as, for example, stopping operation of industrial machines 10 that are part of an assembly line with the affected industrial machine and whose continued operation while the necessary tasks are performed on the affected industrial machine 10 would be undesirable. In some embodiments, a current or anticipated error condition for one or more industrial machines 10 requires the performance of more complicated tasks, such that the central controller 300 is configured to transmit an alarm, warning, notification, message, etc. to a user (i.e., a technician, engineer, maintenance crew member, etc.) of the system 1, which instructs the user to perform a particular task, or sequence of tasks, on one or more of the industrial machines 10 to correct or prevent the occurrence of any current or anticipated error conditions. In some embodiments, the central controller 300 is configured to automatically generate work orders for the user, which include specific instructions to perform one or more tasks, or sequence of tasks, on the affected industrial equipment 10, as determined by the processing of the logging data and/or sensor information by the central controller 300.

In the example embodiment shown in FIG. 1C, the central controller 300 comprises, or is in communication with, a database 700. The database comprises entries of historical error conditions for all of the industrial machines 10 being monitored and/or controlled by the system 1, as well as entries of logging data transmitted by the same type of industrial machine and/or sensor information obtained before, during, and after (e.g., ±10 minutes) each occurrence of the historical error conditions. The central controller 300 is configured to compare the standardized logging messages to the logging data, sensor information, and/or standardized logging messages associated with the historical error conditions for any of the plurality of industrial machines to determine whether the industrial machine 10 is likely experiencing a current or anticipated error condition.

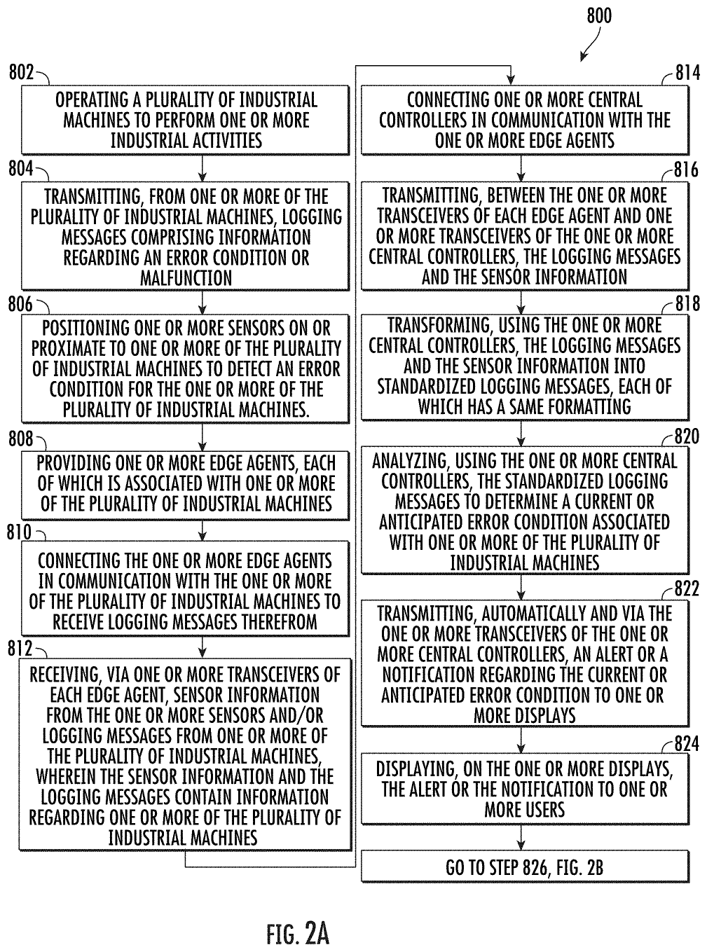

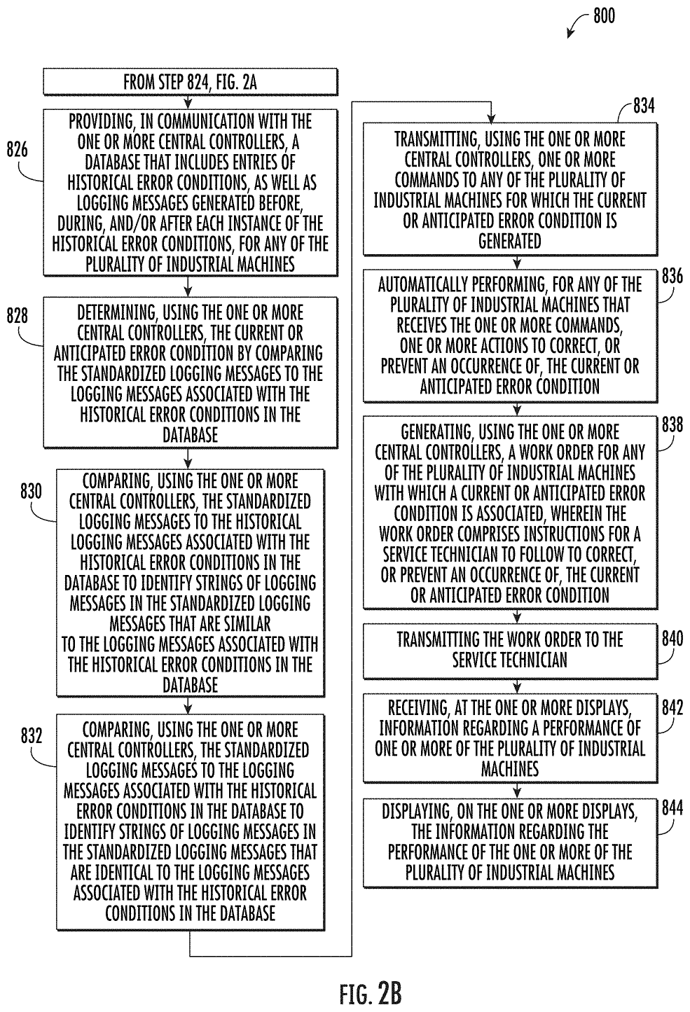

FIGS. 2A and 2B illustrate a flow chart representing various stages of a method, generally designated 800, for reducing downtime associated with one or more error conditions of industrial machines according to some example embodiments of the presently disclosed subject matter. FIG. 2B is a continuation of FIG. 2A and, likewise, FIG. 2C is a continuation of FIG. 2B. Although the flow chart boxes appear to be a sequential ordering of steps in the method 800, those having ordinary skill in the art will appreciate that any of the steps depicted in FIG. 2A through FIG. 2C can be completed in order or out of order. In other words, some steps may be performed simultaneously or sequentially with each other and other steps may be performed multiple times before proceeding to a next step. Additionally, the one or more processors of the edge agents 100 or the central controller 300 or any other processor associated with performing the method 800 can have multiple cores, each of which performs different parts of the method 800 at the same time. The method 800 can be performed in any order. In fact, some steps depicted in the method 800 can be omitted entirely. Not every step in the method 800 is required. Therefore, the numbered steps should not be read as indicating any particular order of the steps being taken, but rather used for descriptive purposes only to ease in the description of the method 800.

The remainder of the description of FIGS. 2A through 2C will be described in numerical order for ease of description. A first step 802 of the method 800 comprises operating a plurality of industrial machines to perform one or more industrial activities. One example of such an industrial activity is mail processing. A second step 804 of the method 800 comprises transmitting, from one or more of the plurality of industrial machines, logging messages comprising information regarding an error condition or malfunction. A third step 806 of the method 800 comprises positioning one or more sensors on or proximate to one or more of the plurality of industrial machines to detect an error condition for the one or more of the plurality of industrial machines. A fourth step 808 of the method 800 comprises providing one or more edge agents, each of which is associated with one or more of the plurality of industrial machines. A fifth step 810 of the method 800 comprises connecting the one or more edge agents in communication with the one or more of the plurality of industrial machines to receive logging messages therefrom. As described elsewhere herein, the edge agents can in at least some or all embodiments collect logging data from the industrial machines and/or sensor information from the one or more sensors. For example, the edge agents monitor (e.g., search for) configured files where the industrial equipment is configured to write logging data (e.g., error logs, status, and/or error messages) during operation of the industrial equipment. This logging data is monitored continuously by an associated one of the edge agents and is transmitted (e.g., streamed in real-time) to a central controller where further filtering and transformation of the logging data and/or sensor information occurs in real-time. The edge agents and the central controllers are configured to monitor logging data and/or sensor information and to issue commands on the basis of the same, based on the types of industrial machines for which such logging data and/or sensor information is being generated.

A sixth step 812 of the method 800 comprises receiving, via one or more transceivers of each edge agent, sensor information from the one or more sensors and/or logging messages from one or more of the plurality of industrial machines, wherein the sensor information and the logging messages contain information regarding one or more of the plurality of industrial machines. A seventh step 814 of the method 800 comprises connecting one or more central controllers in communication with the one or more edge agents. An eighth step 816 of the method 800 comprises transmitting, between the one or more transceivers of each edge agent and one or more transceivers of the one or more central controllers, the logging messages and the sensor information. A ninth step 818 of the method 800 comprises transforming, using the one or more central controllers, the logging messages and the sensor information into standardized logging messages, each of which has a same formatting.

A tenth step 820 of the method 800 comprises analyzing, using the one or more central controllers, the standardized logging messages to determine a current or anticipated error condition associated with one or more of the plurality of industrial machines. An eleventh step 822 of the method 800 comprises transmitting, automatically and via the one or more transceivers of the one or more central controllers, an alert or a notification regarding the current or anticipated error condition to one or more displays. A twelfth step 824 of the method 800 comprises displaying, on the one or more displays, the alert or the notification to one or more users.

The central controller transforms the logs into standardized logging messages, each of which has a standardized format. The standardized format is based on the data model created for the industrial machine. A custom code (e.g., a set or sets of executable instructions) can run on the central controller and search for commonality among various entries (e.g., messages) in the logging data and then convert these common entries into a standardized format. For example, since each industrial machine of a different type and/or manufacturer is unique in the way that logging data is generated, the logging data is usable with and through a data engineering process to identify the logging data of interest, based on predetermined use cases for remote monitoring and analytics. When the logging data of interest is identified in various parts of a log file (e.g., an unstructured log file), the logging data of interest is extracted using scripts (e.g., a set or sets of executable instructions) and data transformation methods in real-time. These extracted data elements are then stored in a structured database, which is accessible to the central controllers for executing algorithms to perform the necessary computations in determining the presence of a current or anticipated error condition.

Thus, a thirteenth step 826 of the method 800 comprises providing, in communication with the one or more central controllers, a database that includes entries of historical error conditions, as well as historical logging messages that were generated before, during, and/or after each instance of the historical error conditions, for any of the plurality of industrial machines. A fourteenth step 828 of the method 800 comprises determining, using the one or more central controllers, the current or anticipated error condition by comparing the standardized logging messages to the logging messages associated with the historical error conditions in the database. A fifteenth step 830 of the method 800 comprises comparing, using the one or more central controllers, the standardized logging messages to the historical logging messages associated with the historical error conditions in the database to identify strings of logging messages in the standardized logging messages that are substantially identical to the logging messages associated with the historical error conditions in the database.

A sixteenth step 832 of the method 800 comprises comparing, using the one or more central controllers, the standardized logging messages to the logging messages associated with the historical error conditions in the database to identify strings of logging messages in the standardized logging messages that are identical to the logging messages associated with the historical error conditions in the database. A seventeenth step 834 of the method 800 comprises transmitting, using the one or more central controllers, one or more commands to any of the plurality of industrial machines for which the current or anticipated error condition is generated. An eighteenth step 836 of the method 800 comprises automatically performing, for any of the plurality of industrial machines that receives the one or more commands, one or more actions to correct, or prevent an occurrence of, the current or anticipated error condition. A nineteenth step 838 of the method 800 comprises generating, using the one or more central controllers, a work order for any of the plurality of industrial machines with which a current or anticipated error condition is associated, wherein the work order comprises instructions for a service technician to perform to correct, or prevent an occurrence of, the current or anticipated error condition. A twentieth step 840 of the method 800 comprises transmitting the work order to the service technician. A twenty-first step 842 of the method 800 comprises receiving, at the one or more displays, information regarding a performance of one or more of the plurality of industrial machines. A twenty-second step 844 of the method 800 comprises displaying, on the one or more displays, the information regarding the performance of the one or more of the plurality of industrial machines.

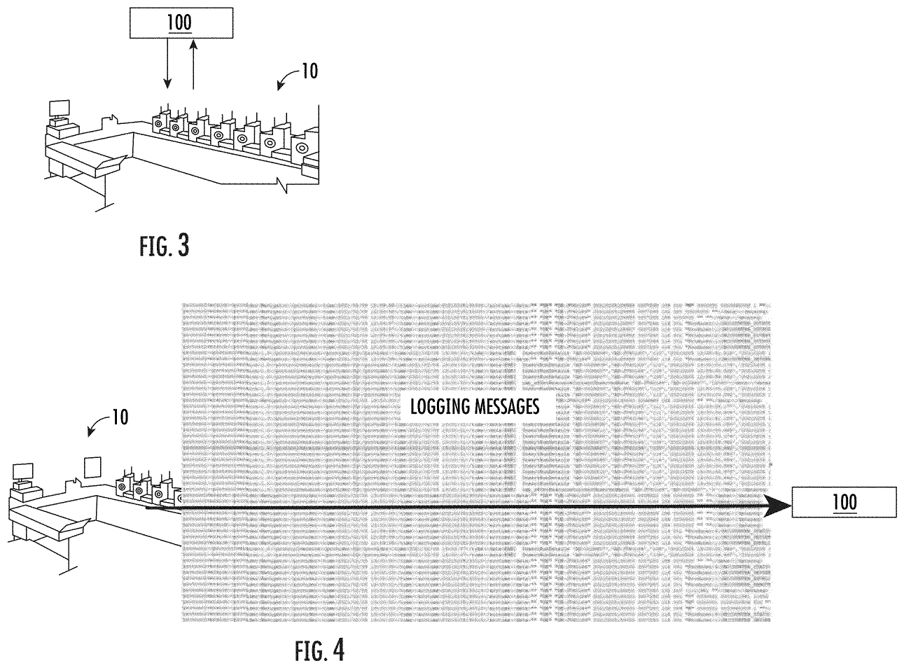

FIG. 3 schematically illustrates an industrial machine 10 that is connected to an example embodiment of an edge agent 100 for bidirectional communication. A sensor 200 is schematically shown in a position, relative to the industrial machine 10, to detect one or more operational parameters of the industrial machine 10. The edge agent is configured to receive logging data from the industrial machine 10 and/or sensor information from the sensor 200 and to also transmit one or more commands (e.g., instructions or other messages) from the central controller 300 (see, e.g., FIGS. 1A, 1C) or a user, whether locally at or remote from the edge agent 100, to the industrial machine 10 to cause the industrial machine 10 to execute a specified action, or series of actions, according to the one or more commands received.

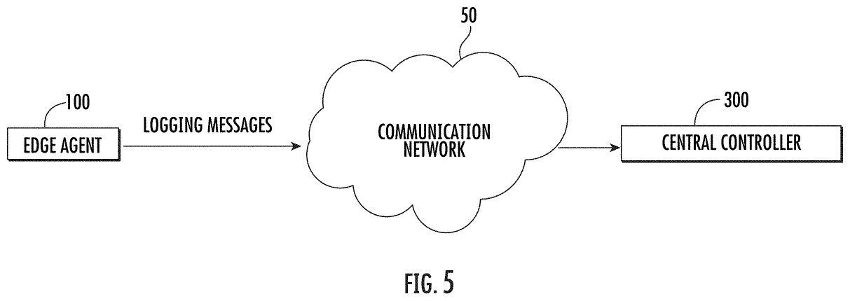

FIG. 4 schematically illustrates the industrial machine 10 transmitting (e.g., forwarding) the logging data to the edge agent 100. As discussed elsewhere herein, it should be noted that industrial machines 10 that are of different types and/or are from different manufacturers generate logging data containing information and/or messages of a plurality of different formats. Thus, the edge agent 100 is configured to receive such logging data having any possible format, including unformatted or raw data, and to transmit (e.g., forward) such logging data to the central controller 300 for processing to detect current or anticipated error conditions for any of a plurality of different industrial machines 10 without regard to the manufacturer or type of the industrial machine 10.

FIG. 5 schematically illustrates an example embodiment of a network topology showing connections that allow unidirectional and/or bidirectional communication between the edge agents 100 and the central controller 30 through the communication network 50. In some embodiments, the communication network is the Internet and one or more of the edge agents 100 transmit logging data and/or sensor information to the central controller 300 via the Internet.

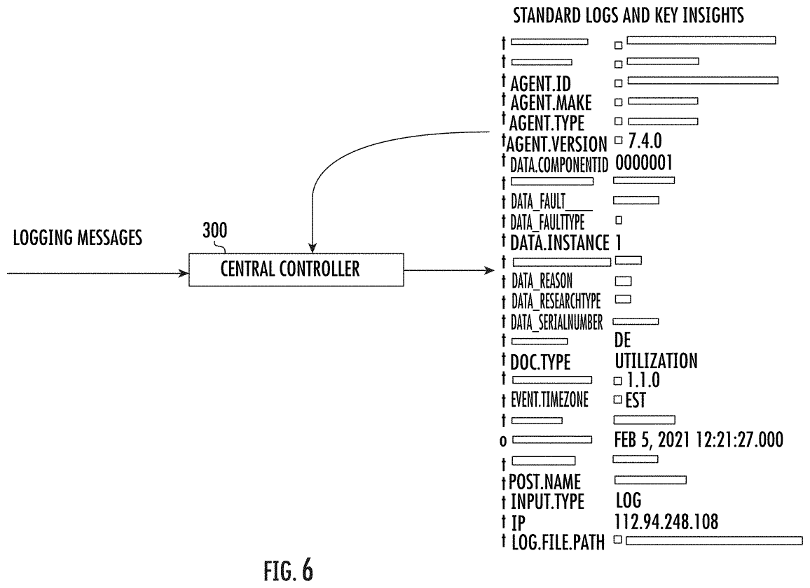

FIG. 6 schematically illustrates the logging data and/or sensor information being converted into standardized logging messages according to an example embodiment of the present disclosure. For example and without limitation, the central controller 300 receives the logging data and/or sensor information from each of the edge agents 100 with which the central controller 300 is associated and is configured to generate, for some or all of the logging data and/or sensor information received, standardized logging messages that have a standardized format. The central controller 300 is configured to parse (e.g., to actively search for key words, phrases, sensor values, and the like) the logging data and/or the sensor information for key insights and to generate standardized logging messages containing the key insights. In some embodiments, there is a one-to-one ratio of entries received for the logging data and/or the sensor information to standardized logging messages generated. In some embodiments, only logging data and/or sensor information that contains a key insight is transformed into a standardized logging message, such that fewer standardized logging messages are generated than there are entries received in the form of logging data and/or sensor information. The central controller 300 is configured to extract the key insights from the logging data and/or sensor information and generate a corresponding standardized logging message for each entry of logging data and/or sensor information received by inserting the key insights into the standardized logging message using a standard format.

In some embodiments, a composite logging message (e.g., a composite standardized logging message) can be generated based on analyzing one or more entries of logging data and/or sensor information received from any of the edge agents 100. Thus, instead of the one-to-one ratio of standardized logging messages to un-processed entries of logging data and/or sensor information, the ratio is less than a one-to-one ratio, meaning that fewer standardized logging messages are generated than there are entries of logging data and/or sensor information received. In some embodiments, after the key insights from the un-processed logging data and/or sensor information are extracted and transformed into standardized logging messages, the central controller 300 is configured to analyze the standardized logging messages using various algorithms (e.g., which can be stored in a memory thereof) to determine whether the standardized logging messages indicate the a current or anticipated error condition is occurring or is likely to occur within a prescribed or specified period of time at the industrial machine 10 associated with the logging data and/or sensor information.

In order to determine whether the standardized logging messages indicate the occurrence of a current or future error condition on the industrial machine 10, the central controller 300 is configured to communicate with a database containing entries of historical error conditions associated with industrial machines 10 of a particular type and/or manufacturer and also the standardized logging messages, logging data, and/or sensor information associated with (e.g., generated before, during, and/or after the occurrence of) the historical error conditions from which the logging data and/or sensor information was received. The central controller 300 is configured to query search, or cross-reference) the entries contained within this database and to compare currently received standardized logging messages, logging data, and/or sensor information to the entries of the same, or substantially similar, instances or strings of standardized logging messages, logging data, and/or sensor information that were generated during a known historical error condition to analyze patterns of matching sequences of standardized logging messages, logging data, and/or sensor information associated with particular instances of historical error conditions. In some embodiments, the central controller 300 utilizes machine learning and other analytical techniques to better understand the entries, or sequences thereof, of sequences of standardized logging messages, logging data, and/or sensor information being received and how such entries or sequences of entries compare to the standardized logging messages, logging data, and/or sensor information associated with the historical error conditions stored in the database. Thus, the central controller 300 is configured to learn from and adapt to the patterns of standardized logging messages, logging data, and/or sensor information stored in the database associated with historical error conditions to be able to detect the occurrence of current or anticipated error conditions in the currently received standardized logging messages, logging data, and/or sensor information based on the ongoing analysis of the data stored in the database.

The central controller 300 is configured to process the standardized logging messages, the logging data, and/or the sensor information to determine the occurrence of a current or anticipated error condition in any industrial machine 10 from which the central controller 300 is receiving such logging data and/or sensor information. When the central controller 300 receives logging data and/or sensor information from an edge agent 100, the central controller 300 is configured to determine that such logging data and/or sensor information is a part of a sequence that corresponds to (e.g., is transmitted before, during, and/or after) the standardized logging messages, logging data, and/or sensor information contained within the database and associated with an error condition for an industrial machine 10 of a same type and/or manufacturer.

The raw, or unprocessed, logging data and/or sensor information is received and transformed into one or more (e.g., a plurality of) standardized logging messages that are in a standard format. These standardized logging messages are then analyzed by the central controller 300, which executes one or more algorithms based on use case (e.g., the type, manufacturer, and/or task being performed by an industrial machine 10). For example, FIG. 9 shows an example illustration of a real-time visualization (e.g., a graphical chart) showing stoppages for an industrial machine 10 during operation of the industrial machine 10. One such example algorithm applied by the central controller 300 is configured to receive, as one or more data inputs, and to categorize, in various stoppage categories (e.g., sorted by the cause associated with the stoppage) the raw, or unprocessed, logging data and/or sensor information received, where the stoppages shown in the visualization are occurring in real-time. Based on specific thresholds (e.g., allowable number of incidences) for each “category” of stoppages, one or more algorithms are configured to trigger alerts and/or notifications to make service personnel aware of the incidence of stoppages over a prescribed threshold. In some embodiments, these alerts and/or notifications provide recommended actions for remedying the cause of the error condition based on trends identified in the historical error conditions of the database and currently received standardized error messages, logging data, and/or sensor information.

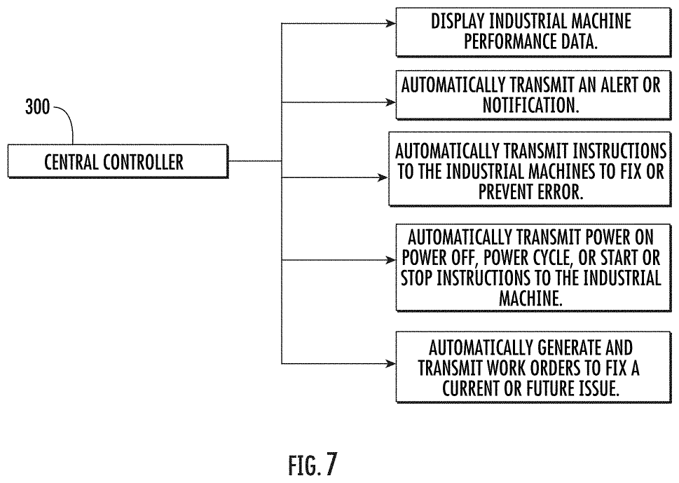

FIG. 7 schematically illustrates example actions that the central controller 300 can execute when the standardized logging messages have been processed (e.g., by cross-reference of one or more standardized error messages to entries in the database). Once the central controller 300 has analyzed the standardized logging messages and determined that a current or anticipated error condition is occurring or is otherwise imminent (e.g., likely to occur within a prescribed period of time), the central controller 300 is configured to take action (e.g., by issuing commands based on the error condition determined to be occurring, or about to occur) based on the type and cause of the current or anticipated error condition. For example and without limitation, the central controller 300 is configured to transmit commands (e.g., messages and/or instructions) to the affected industrial machine 10 via the edge agent 100 to remedy, alleviate, and/or prevent the occurrence of the error condition. In some embodiments, these commands are instructions to power off, power on, power cycle, or alter (e.g., stop and/or start) the operation of one or more components of the affected industrial machine 10. Such commands can be used to clear error conditions that can be resolved remotely (e.g., without requiring direct, physical, access to the affected industrial machine 10).

However, in some instances, such current or anticipated error conditions require physical intervention by a user (e.g., service personnel or end-user) at the physical location of the affected industrial equipment 10, in which case the central controller 300 is configured to transmit commands (e.g., messages and/or instructions) to a user of the system 1 or the affected industrial equipment 10. In some embodiments, the commands sent to the user comprise instructions to power off, power on, power cycle, start or stop instructions, or instructions to alter operation of one or more components of the affected industrial machine 10. In some instances, the commands transmitted to the user comprise instructions regarding how to fix or replace one or more components of the affected industrial machine 10, how to address (e.g., remove) a material jam (e.g., a paper jam or other material jam), how to reconfigure the affected industrial machine 10, and/or how to otherwise alter the affected industrial machine 10, or the operation of the affected industrial machine 10, to resolve or prevent the occurrence of any such current or anticipated error condition.

In some embodiments, the commands sent to the user by the central controller 300 comprise an alert, notification, warning, alarm, and/or error message regarding the present or imminent occurrence of the current or anticipated error condition. The alert, notification, warning, alarm, and/or error message can be transmitted in any form and via any suitable communication medium, including, for example and without limitation, by email, automated phone call, text message (i.e., SMS), a pop-up on a terminal or screen, such as the display, a push notification on a mobile device, a warning or alarm sound on the affected industrial machine 10, edge agent 100, or other location, or any other suitable warning, alarm, or error message. In some embodiments, the central controller 300 is configured to transmit any of the messages, instructions, or warnings to the user's personal electronic device(s) (e.g., mobile phone, smart phone, tablet, PC, server, personal digital assistant, an FPGA, a monitor, or any other suitable device to which the user has access and is in a location where the user may see and/or interact with the warning, message, or notification).

In some embodiments, the central controller 300 is configured to automatically generate and transmit one or more work orders to fix or prevent an occurrence of a current or anticipated error condition for an affected industrial machine 10. In some such embodiments, the central controller 300 is configured to generate and transmit such work orders to users, engineers, service technicians, and the like to fix the current or anticipated error condition identified by the central controller 300 on the industrial equipment and/or, in some instances, perform maintenance to prevent the occurrence of an anticipated error condition.

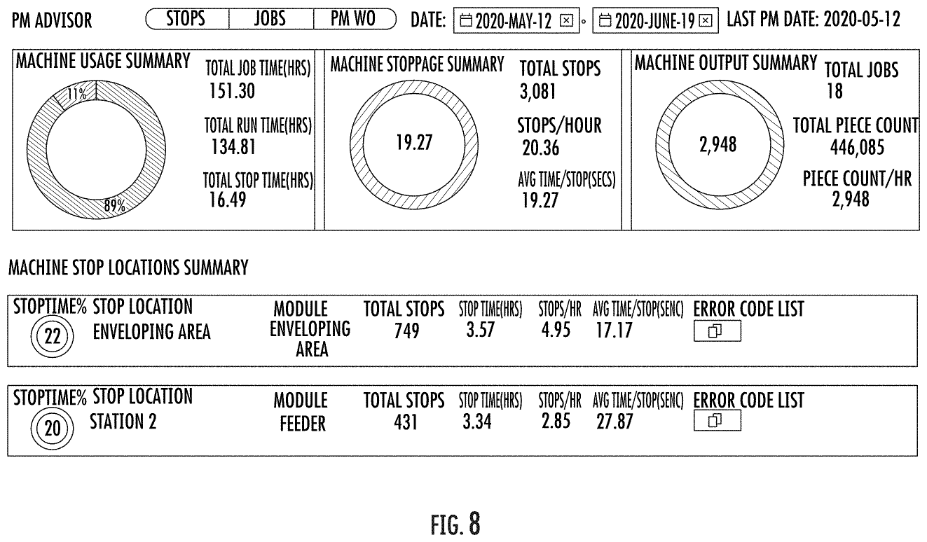

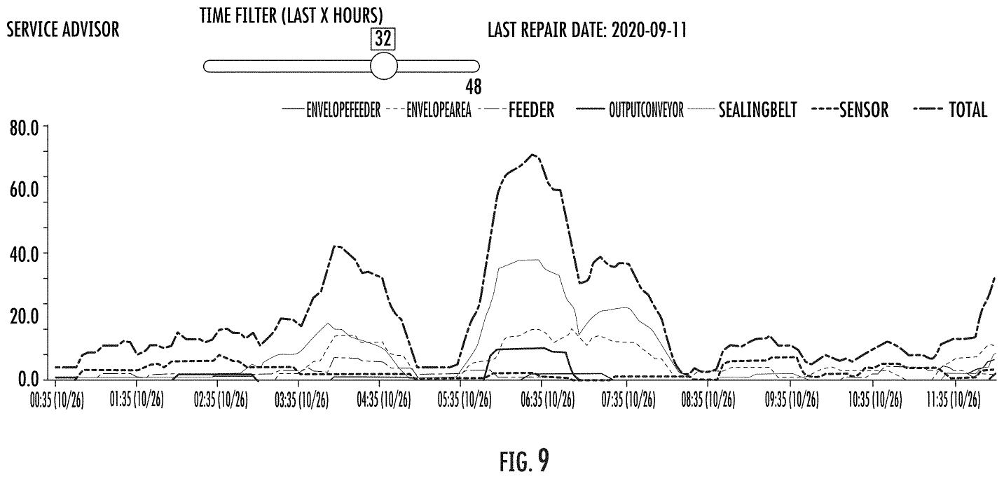

In some embodiments, the central controller 300 is configured to transmit performance data regarding any industrial machine 10 with which the central controller 300 is in communication to a display 500, or other suitable user terminal, for viewing and monitoring (e.g., by service personnel). FIG. 8 and FIG. 9 illustrate example embodiments of various charts and visualizations of data that may be used to help monitor the performance of the industrial machines 10 being monitored by the edge agents 100, the sensors 200, and the central controllers 300.

The present subject matter can be embodied in other forms without departure from the spirit and essential characteristics thereof. The embodiments described therefore are to be considered in all respects as illustrative and not restrictive. Although the present subject matter has been described in terms of certain specific embodiments, other embodiments that are apparent to those of ordinary skill in the art are also within the scope of the present subject matter.

1. A system for reducing downtime, the system comprising:
one or more displays;
a plurality of industrial machines configured to generate logging messages, each logging message comprising information regarding a corresponding one of the plurality of industrial machines;
one or more sensors positioned on or proximate to one or more of the plurality of industrial machines, wherein each sensor is configured to detect one or more operational parameters for the one or more of the plurality of industrial machines to which the sensor is positioned on or proximate to;
one or more edge agents, each edge agent being associated with one or more industrial machines of the plurality of industrial machines and comprising:
one or more processors in communication with the one or more industrial machines with which the edge agent that comprises the one or more processors is associated; and
one or more transceivers configured to receive sensor information regarding one or more operational parameters from at least some of the one or more sensors and/or the logging messages from the one or more industrial machines with which the edge agent that comprises the one or more transceivers is associated; and
one or more central controllers, each of which comprises:
one or more processors in communication with at least some of the one or more edge agents; and
one or more transceivers;
wherein each central controller is configured to:
receive, via the one or more transceivers of the one or more central controllers, the logging messages and the sensor information from the one or more edge agents in communication therewith;
transform, via the one or more processors of the one or more central controllers, the logging messages and the sensor information into standardized logging messages, each of which has a same formatting;
analyze the standardized logging messages to determine a current or anticipated error condition associated with one or more of the plurality of industrial machines; and
automatically transmit, via the one or more transceivers of the one or more central controllers, an alert and/or a notification regarding the current or anticipated error condition to the one or more displays; and
wherein the one or more displays are configured to receive and display the alert and/or the notification to one or more users of the system.

2. The system of claim 1, wherein the one or more displays comprise a display of a mobile personal electronic device.

3. The system of claim 2, wherein the mobile personal electronic device is configured to transmit one or more commands from the one or more users to deactivate, or change an operational state of, any of the plurality of industrial machines.

4. The system of claim 1, wherein the one or more central controllers comprise a database that includes instances of historical error conditions and historical logging messages that were generated before, during, and/or after each instance of the historical error conditions for any of the plurality of industrial machines.

5. The system of claim 4, wherein the one or more processors of the one or more central controllers are configured to determine the current or anticipated error condition by comparing the standardized logging messages to the historical logging messages.

6. The system of claim 4, wherein the one or more processors of the one or more central controllers are configured to compare the standardized logging messages to the historical logging messages to identify series, or sequences, of the standardized logging messages that are substantially similar to the historical logging messages that were generated before, during, and/or after each instance of the historical error conditions.

7. The system of claim 4, wherein the one or more processors of the one or more central controllers are configured to compare the standardized logging messages to the historical logging messages to identify series, or sequences, of the standardized logging messages that are identical to the historical logging messages that were generated before, during, and/or after each instance of the historical error conditions.

8. The system of claim 1, wherein the plurality of industrial machines comprise at least two different types of industrial machines.

9. The system of claim 8, wherein each edge agent is configured to receive logging messages from each of the different types of industrial machines.

10. The system of claim 1, wherein each edge agent is located in a same location as the one or more industrial machines from which the edge agent is configured to receive the logging messages.

11. The system of claim 1, wherein the plurality of industrial machines comprises one or more industrial mail processing machines.

12. The system of claim 1, wherein the one or more transceivers of the one or more central controllers are configured to transmit one or more commands to any of the plurality of industrial machines for which the current or anticipated error condition is determined, wherein any of the plurality of industrial machines that receives the one or more commands are configured to automatically perform one or more actions to correct, or prevent an occurrence of, the current or anticipated error condition.

13. The system of claim 12, wherein the one or more actions comprise any of powering on, powering off, power cycling, and/or starting or stopping operation of a part or component associated with any of the plurality of industrial machines that receives the one or more commands.

14. The system of claim 1, wherein the one or more processors of the one or more central controllers are configured to generate, and the one or more transceivers of the one or more central controllers are configured to transmit, a work order to a service technician for any of the plurality of industrial machines with which the current or anticipated error condition is associated, the work order comprising instructions for the service technician to correct, or prevent an occurrence of, the current or anticipated error condition.

15. The system of claim 1, wherein the one or more displays are configured to receive information regarding a performance of one or more of the plurality of industrial machines and to display the information regarding the performance of the one or more of the plurality of industrial machines.

16. The system of claim 1, wherein the logging messages generated by the plurality of industrial machines and/or the one or more operational parameters detected by the one or more sensors comprises and/or indicates one or more error conditions associated with one or more of the plurality of industrial machines.

17. A method of reducing downtime, the method comprising:
performing, using a plurality of industrial machines, one or more industrial activities, wherein each industrial machine can generate logging messages, each logging message comprising information regarding a corresponding one of the plurality of industrial machines that generates the logging message;
positioning one or more sensors on or proximate to one or more of the plurality of industrial machines, wherein each sensor detects one or more operational parameters for the one or more of the plurality of industrial machines to which the sensor is positioned on or proximate to;
providing one or more edge agents, each of which is associated with one or more industrial machines of the plurality of industrial machines and comprises one or more processors and one or more transceivers;
connecting the one or more processors in communication with the one or more industrial machines with which the edge agent that comprises the one or more processors is associated;
receiving, via the one or more transceivers, sensor information regarding one or more operational parameters from at least some of the one or more sensors and/or the logging messages from the one or more industrial machines with which the edge agent that comprises the one or more transceivers is associated;
connecting one or more central controllers in communication with at least some of the one or more edge agents;
receiving, via the one or more transceivers of the one or more central controllers, the logging messages and the sensor information from the one or more edge agents in communication therewith;
transforming, using the one or more processors of the one or more central controllers, the logging messages and the sensor information into standardized logging messages, each of which has a same formatting;
analyzing, using the one or more processors of the one or more central controllers, the standardized logging messages to determine a current or anticipated error condition associated with one or more of the plurality of industrial machines;
transmitting, automatically and via the one or more transceivers of the one or more central controllers, an alert and/or a notification regarding the current or anticipated error condition to one or more displays; and
displaying, on the one or more displays, the alert and/or the notification to one or more users.

18. The method of claim 17, wherein the one or more displays comprise a display of a mobile personal electronic device.

19. The method of claim 18, wherein the mobile personal electronic device comprises an input and a transceiver, the method comprising transmitting one or more commands from the one or more users to deactivate, or change an operational state of, any of the plurality of industrial machines.

20. The method of claim 19, comprising providing, in communication with the one or more central controllers, a database that includes instances of historical error conditions and historical logging messages that were generated before, during, and/or after each instance of the historical error conditions for any of the plurality of industrial machines.

21. The method of claim 20, comprising determining, using the one or more processors of at least one of the one or more central controllers, the current or anticipated error condition by comparing the standardized logging messages to the historical logging messages.

22. The method of claim 20, comprising comparing, using the one or more processors of at least one of the one or more central controllers, the standardized logging messages to the historical logging to identify series, or sequences, of the standardized logging messages that are substantially similar to the historical logging messages that were generated before, during, and/or after each instance of the historical error conditions.

23. The method of claim 20, comprising comparing, using the one or more processors of at least one of the one or more central controllers, the standardized logging messages to the historical logging messages to identify series, or sequence, of the standardized logging messages that are identical to the historical logging messages that were generated before, during, and/or after each instance of the historical error conditions.

24. The method of claim 17, wherein the plurality of industrial machines comprise at least two different types of industrial machines.

25. The method of claim 24, comprising receiving, for each edge agent, logging messages from each of the different types of industrial machines.

26. The method of claim 17, wherein each edge agent is located in a same location as the one or more industrial machines from which the edge agent receives the logging messages.

27. The method of claim 17, wherein the plurality of industrial machines comprises one or more industrial mail processing machines.

28. The method of claim 17, comprising:
transmitting, using one or more transceivers of at least one of the one or more central controllers, one or more commands to any of the plurality of industrial machines for which the current or anticipated error condition is determined; and
automatically performing, at any of the plurality of industrial machines that receives the one or more commands, one or more actions to correct, or prevent an occurrence of, the current or anticipated error condition.

29. The method of claim 28, wherein the one or more actions comprise any or powering on, powering off, power cycling, and/or starting or stopping operation of a part or component associated with any of the plurality of industrial machines that receives the one or more commands.

30. The method of claim 17, comprising:
generating, using the one or more processors of at least one of the one or more central controllers, a work order for any of the plurality of industrial machines with which the current or anticipated error condition is associated, wherein the work order comprises instructions for a service technician to perform to correct, or prevent an occurrence of, the current or anticipated error condition; and
transmitting, using the one or more transceivers of the at least one of the one or more central controllers, the work order to the service technician.

31. The method of claim 17, comprising:
receiving, at the one or more displays, information regarding a performance of one or more of the plurality of industrial machines; and
displaying, on the one or more displays, the information regarding the performance of the one or more of the plurality of industrial machines.

32. The method of claim 17, wherein the logging messages generated by the plurality of industrial machines and/or the one or more operational parameters detected by the one or more sensors comprises and/or indicates one or more error conditions associated with one or more of the plurality of industrial machines.
